(19) United States
(12) Patent Application Publication
(10) Pub. No.: US 2009/0241995 A1
(43) Pub. Date: Oct. 1, 2009

(54) SUBSTRATE CLEANING METHOD AND APPARATUS

(75) Inventor: Mark H. Somervell, Austin, TX (US)

Correspondence Address: WOOD, HERRON & EVANS, LLP (TOKYO ELECTRON), 2700 CAREW TOWER, 441 VINE STREET, CINCINNATI, OH, 45202, US

(73) Assignee: TOKYO ELECTRON LIMITED, Tokyo (JP)

(21) Appl. No.: 12/059,206

(22) Filed: Mar. 31, 2008

(51) Int. Cl. B08B 7/04; B08B 3/04; B08B 3/08; B08B 3/10; B08B 5/02

(52) U.S. Cl. 134/30; 134/33; 134/37; 134/36; 134/99.1

(57) ABSTRACT

In a method of removing a film residue from a wafer in a substrate processing system, a surface of the wafer is exposed to a processing liquid to thereby lift a first portion of the film residue off the surface of the wafer. In addition, a continuous or pulsed stream of pressurized gas is applied against the surface of the wafer to remove a second portion of the film residue from the wafer. The method may include rotating the wafer relative to the stream of pressurized gas. The stream of pressurized gas may be applied subsequent to exposing the surface of the wafer to the processing liquid and any residual processing liquid may be removed with the second portion of film residue by the stream of pressurized gas. Alternatively, the stream of pressurized gas may be applied concurrently with the processing liquid to remove the film residue and processing liquid in a single step. In an embodiment of an apparatus for removing film residue, a liquid dispensing device and a pressurized gas dispensing device cooperate to apply processing liquid and pressurized gas, concurrently or sequentially, to a substrate surface.

### FIELD OF THE INVENTION

The present invention relates to a substrate cleaning method, and more particularly, to a method for removing a film from a substrate, where the amount of film residue remaining on the surface after the cleaning is minimized or eliminated.

### BACKGROUND OF THE INVENTION

Substrate processing systems typically subject semiconductor substrates (e.g., wafers) to various cleaning processes in semiconductor device fabrication. For example, after a patterned resist film is developed in a developing module, it is transferred to another system to strip the photoresist off the substrate. The stripping may be accomplished in a plasma etch tool. This method is not advantageous because first, there is a prohibitively high potential for damage to the substrate by plasma etching, and second, plasma etching tools are typically located in another area of the fabrication line apart from the photolithography tools such that the substrate must be inconveniently removed from the photolithography area during that processing sequence for removal of the photoresist. Alternatively, the stripping of the photoresist may be accomplished in a coating module in the photolithography line, where the substrate is first exposed to a processing liquid containing an organic solvent to dissolve and remove the patterned resist film from the substrate prior to a subsequent coating step. However, solvent processing typically leaves resist residue remaining on the surface of the substrate, i.e., it is not completely effective at removing the photoresist. These residues are detrimental to the yield of the microelectronic devices being generated on the wafer.

There is thus a need for a method of removing photoresist that can be accomplished in the photolithography processing area and that is effective to minimize or eliminate residues remaining on the surface of the wafer.

### SUMMARY OF THE INVENTION

In one embodiment, a method of removing a film residue from a wafer in a substrate processing system includes exposing a surface of the wafer to a processing liquid to thereby lift a first portion of the film residue off the surface of the wafer, and applying a stream of pressurized gas against the surface of the wafer to remove a second portion of the film residue from the wafer. The application of the stream of pressurized gas may be sequentially after or concurrently with the exposure of the wafer to the processing liquid.

In another embodiment, a method of removing a film residue from a wafer in a substrate processing system includes exposing a surface of the wafer to a processing liquid to thereby lift a first portion of the film residue off the surface of the wafer. Further, while rotating the wafer, a stream of pressurized gas is applied against the surface of the wafer from a center portion thereof radially outward to an edge portion thereof to remove the processing liquid and a second portion of the film residue from the wafer. Again, the application of the stream of pressurized gas may be sequentially after or concurrently with the exposure of the wafer to the processing liquid.

In another embodiment, an apparatus for removing a film residue from a wafer in a substrate processing system includes a support structure that is adapted to support the wafer, and a liquid dispensing device is adapted to dispense a processing liquid onto a surface of the wafer. Further, a gas dispensing device cooperates with the liquid dispensing device and is adapted to apply a stream of pressurized gas onto the surface of the wafer to thereby lift the film residue off the surface of the wafer.

### BRIEF DESCRIPTION OF THE DRAWINGS

The accompanying drawings, which are incorporated in and constitute a part of this specification, illustrate embodiments of the invention and, together with a general description of embodiments of the invention given above, and the detailed description given below, serve to explain embodiments of the invention.

FIG. 1 is a plan view of a substrate processing system;

FIG. 2 is a side view of the substrate processing system;

FIG. 3 is a plan view of a substrate processing unit;

FIG. 4 is a simplified circuit diagram of circulation of a processing liquid in a substrate processing system;

FIGS. 5A-5C schematically show cross-sectional views corresponding to processing steps used in a first sequential step of removing a first portion of a film from a wafer according to an embodiment of the invention;

FIGS. 6A-6C are perspective views schematically depicting a portion of the substrate processing system and processing steps used in a second sequential step of removing a second portion of a film from a wafer according to an embodiment of the invention;

FIG. 6D is a perspective view of a portion of the substrate system in accordance with an alternative embodiment of the invention;

FIG. 6E is a perspective view similar to FIG. 6A showing the liquid dispensing device in an orientation different from that shown therein; and

FIGS. 7A-7D schematically show cross-sectional views corresponding to a method for concurrently processing a wafer with both processing liquid and pressurized gas to remove a film from the surface of the wafer according to an embodiment of the invention.

### DETAILED DESCRIPTION OF SEVERAL EMBODIMENTS

Embodiments of the present invention are explained below using a substrate processing system for removing a film from a wafer in a substrate cleaning process. The terms “substrate” and “wafer” are used interchangeably herein to refer to a thin slice of material, such as a silicon crystal or glass material, upon which microcircuits are constructed, for example by diffusion and deposition of various materials. The film can, for example, contain a resist film, a hard mask film, a dielectric film, or a combination of two or more thereof.

In accordance with the present invention, a pressurized gas stream is used in conjunction with a film removal liquid, such as a stripping solvent, to enhance the removal of film residue (fragments) from the wafer surface. In addition, use of the pressurized gas stream decreases the time required to remove the film, and decreases the amount of film removal liquid needed, relative to a process that uses only the film removal liquid. Embodiments of the invention will now be described with reference to the Figures, wherein like reference numerals are used to refer to like parts throughout the several views.

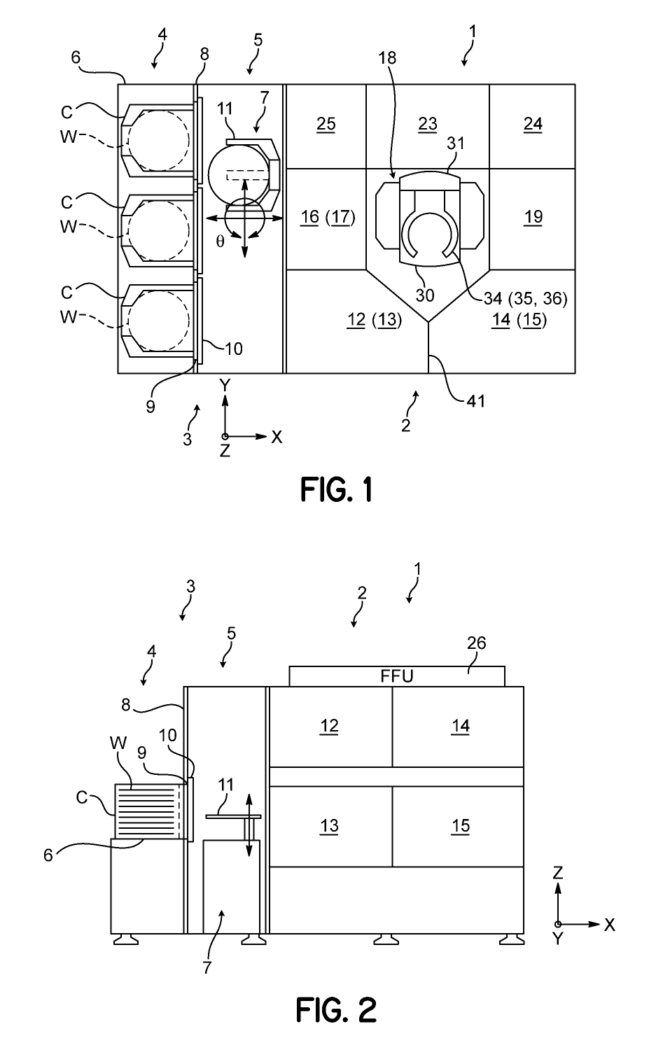

FIGS. 1-4 describe a substrate processing system containing four substrate units, each configured for processing a single wafer at a time. However, embodiments of the invention are not limited to single substrate processing systems, as batch substrate processing systems configured for processing simultaneously a plurality of substrates (e.g., 25 wafers or more) may be utilized. An exemplary batch substrate processing system is described in U.S. Pat. No. 6,990,988. In one example, the batch substrate processing system may be a TEL PR300Z from Tokyo Electron Limited, Akasaka, Japan, that is commonly used for stripping photoresist from 12 inch wafers for back end of line (BEOL) processing.

FIG. 1 is a plan view and FIG. 2 is a side view of a substrate processing system 1 containing a processing unit 2 for performing a film removal/cleaning process on wafers W, and a loading/unloading unit 3 for loading/unloading the wafers W into/out of the processing unit 2.

The loading/unloading unit 3 contains an in/out port section 4 that includes mounts 6 for mounting wafer containers (carriers C). The carriers C can accommodate a plurality (e.g., 25) of wafers W that are horizontally positioned in the carriers C with a predetermined vertical spacing between each wafer W. The loading/unloading unit 3 further contains a substrate transfer interface unit 5 that includes a substrate transfer system 7 for transferring the wafers W between the carriers C and the processing unit 2.

The wafers W are loaded into each carrier C through a lid provided on the side of each carrier C. Shelf plates (not shown) for holding the wafers W at the predetermined vertical spacings are provided inside each carrier C, thereby defining a plurality of wafer slots for holding the wafers W. The wafers W are held in the respective wafer slots with the wafer surfaces for microcircuit fabrication facing up.

In FIG. 1, the three carriers C are mounted on the mounts 6 of the in/out port section 4, and arranged in the Y direction with respect to the horizontal plane. The carriers C are mounted with vertical covers (not shown) facing a partition wall 8 between the in/out port section 4 and the substrate transfer interface unit 5. Openings 9 are formed in the partition wall 8 at positions corresponding to the mounted positions of the carriers C. Opening/closing mechanisms 10 for opening/closing the openings 9 are operated by a shutter or other means that are located near the openings 9. The opening/closing mechanisms 10 can also open/close the vertical covers of the carriers C concurrently with the opening/closing of the openings 9. When the openings 9 are opened to couple the wafers W in the carriers C with the substrate transfer interface unit 5, the substrate transfer system 7 couples the substrate transfer interface unit 5 to the carriers C for transferring the wafers W.

The substrate transfer system 7 in the substrate transfer interface unit 5 can be translated in the Y and Z-direction and rotated an angle theta (θ) in the X-Y plane. The substrate transfer system 7 has a transfer arm 11 that can be translated in the X-direction for retrieving a wafer W. The transfer arm 11 can access all the wafer slots located at different elevations in the carriers C when placed on the mount 6. Furthermore, the transfer arm 11 can access upper and lower substrate transfer units 16, 17 located in the processing unit 2 and configured to transfer wafers W from the in/out port section 4 to the processing unit 2 and from the processing unit 2 to the in/out port section 4.

The processing unit 2 contains a central substrate transfer system 18, substrate transfer units 16, 17, substrate processing units 12, 13, 14, 15, and a heating/cooling unit 19 that includes three heating units (not shown) for heating the wafers W and a cooling unit (not shown) for cooling the wafers W. The central substrate transfer system 18 is coupled to the wafer transfer units 16, 17, the substrate processing units 12, 13, 14, 15, and the heating/cooling unit 19.

The processing unit 2 includes an electrical unit 23 that includes an electric power source (not shown) for operating the substrate processing system 1, a mechanical control unit 24 for operational control of the various components of the substrate processing system 1 and the processing system 1 as a whole, a processing liquid storage unit 25 for storing prescribed processing liquids (e.g., cleaning liquids for film removal or rinse liquids for further rinsing) that are utilized in the substrate processing units 12, 13, 14, 15 during wafer W processing. The electrical unit 23 is connected to a main electric power source (not shown). A fan filter unit (FFU) 26 positioned on top of the processing unit 2 provides down flow of clean air to the respective units of the processing unit 2, including the central substrate transfer system 18.

The electrical unit 23, the processing liquid storage unit 25, and the mechanical control unit 24 are arranged on an outer wall in the processing unit 2 for easy removal from the processing unit 2, and easy maintenance of the substrate transfer units 16, 17, the central substrate transfer system 18, and the heating/cooling unit 19.

The substrate transfer units 16, 17 are configured to transfer wafers W to/from the substrate transfer interface unit 5 and stack the wafers W vertically in the two substrate transfer units 16, 17. For example, the (lower) substrate transfer unit 17 can be used to receive a wafer W to be transferred from the in/out port section 4 to the processing unit 2, and the (upper) substrate transfer unit 16 can be used to receive a wafer W to be transferred from the processing unit 2 to the in/out port section 4.

Part of the down flow of clean air from the fan filter unit (FFU) 26 flows to the substrate transfer interface unit 5 through a space between the wafer transfer units 16, 17 and through a space above the substrate transfer unit 16. Thus, the introduction of particles and other contaminants from the substrate transfer interface unit 5 into the processing unit 2 can be minimized and a clean environment maintained in the processing unit 2.

The central substrate transfer system 18 includes a cylindrical support 30 that can be rotated by a rotary drive motor (not shown), and a substrate transfer body 31 that is movable up and down in the Z-direction inside the cylindrical support 30. The substrate transfer body 31 can be rotated within the cylindrical support 30 by the rotation of the cylindrical support 30. The substrate transfer body 31 has three transfer arms 34, 35, 36 that are arranged at different heights and can be independently extended or withdrawn.

The heating/cooling unit 19 contains one cooling unit dedicated for cooling wafers W and three heating units dedicated for heating (or alternatively slow cooling) wafers W. Alternately, the heating/cooling unit 19 may be located in the upper portion of the wafer transfer unit 16, and the space occupied by the heating/cooling unit 19 depicted in FIG. 1 may be utilized for other purposes.

As shown in FIG. 2, the substrate processing units 12, 13, 14, 15 are arranged in two vertical levels, with each level containing two substrate processing units. The substrate processing units 12, 13 and the substrate processing units 14, are symmetrical with respect to the partition 41 between the substrate processing units 12, 13. The substrate processing units 12, 13, 14, 15 may be identical except for their location in the processing unit 2. Below, to illustrate embodiments of the invention, the substrate processing unit 12 is described.

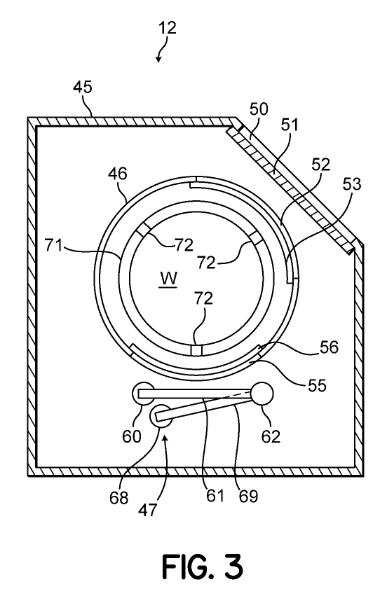

FIG. 3 is a plan view of the substrate processing unit 12. The substrate processing unit 12 contains an external chamber 45 and a process chamber 46 within the external chamber 45 for processing wafers W. Furthermore, the external chamber 45 contains a processing liquid/pressurized gas supply system 47 for supplying processing liquids to the wafer W in the process chamber 46. An opening 50 is formed in the external chamber 45 and an external chamber mechanical shutter 51 opens/closes the opening 50 using an opening/closing mechanism (not shown). When a wafer W is loaded into the substrate processing unit 12 through the opening 50, an opening 52 is opened by process chamber mechanical shutter 53 to allow transfer of the wafer W into the process chamber 46 by one of the transfer arms 34, 35, 36. The process chamber mechanical shutter 53 may be opened by an opening/closing mechanism that is common with the external chamber mechanical shutter 51. An opening 55 is formed in the process chamber 46 by processing liquid supply shutter 56, which is opened/closed, by a drive mechanism (not shown).

The processing liquid/pressurized gas supply system 47 provides a processing liquid that is applied to the top surface of wafer W for at least partially dissolving a resist film on an exposed surface of the wafer W, to clean or strip the resist film. Suitable solvents for use as a processing liquid in the present invention include solvents, such as organic solvents, that are capable of dissolving and/or fragmenting resist material to permit removal of the material from the wafer W. For example, suitable solvents include propylene glycol methyl ether acetate, ethyl lactate, cyclohexanone, gamma-butyrolactone, propylene glycol monomethyl ether, or methyl amyl ketone, or any combination thereof. Processing liquid/pressurized gas supply system 47 could also be configured to supply a rinse liquid, such as deionized water, for further cleaning the wafer W by rinsing dissolved and/or fragmented film residue off the surface of wafer W, for example, after treatment with the processing liquid and pressurized gas. The processing liquid/pressurized gas supply system 47 includes a processing liquid dispensing device such as a liquid supply nozzle 60. A first arm 61 supports the liquid supply nozzle 60 and rotating means 62 rotatably support one end of the first arm 61. Thus, the liquid supply nozzle 60 is supported by the first arm 61 rotatably between a standby position outside the process chamber 46 and a supply position where the liquid supply nozzle 60 supplies processing liquids above wafer W. Furthermore, the liquid supply nozzle 60 can travel above the wafer W in the process chamber 46, from the center portion of the wafer W to the edge portion of the wafer W.

The processing liquid/pressurized gas supply system 47 further includes a pressurized gas dispensing device such as a gas supply nozzle 68. A second arm 69 supports the gas supply nozzle 68 and rotating means 62 rotatably support one end of the second arm 69. Thus, the gas supply nozzle 68 is supported by the second arm 69 rotatably between a standby position outside the process chamber 46 and a supply position where the gas supply nozzle 68 supplies pressurized gas above wafer W. Furthermore, the gas supply nozzle 68 can travel above the wafer W in the process chamber 46, from the center portion of the wafer W to the edge portion of the wafer W. In an alternative embodiment to that shown in FIG. 3, the processing liquid/pressurized gas supply system 47 may be split into two separate supply systems (a liquid supply system and a gas supply system), where a separate rotating means (not shown) rotatably supports the second arm 69 and gas supply nozzle 68. The opening 55 and liquid supply shutter 56 may be configured to accommodate each of the separate liquid and gas supply systems, or another opening and a gas supply shutter (not shown) could be formed to accommodate the separate gas supply system.

The gas supply nozzle 68 can supply the pressurized gas concurrently with the supply of the processing liquid from liquid supply nozzle 60, or sequentially after the supply of the processing liquid. In either sequential or concurrent supply, the pressurized gas can be applied to the wafer W in a steady stream, or in a pulsed stream, i.e., in short bursts. Further, the pressurized gas can be applied in a stream oriented perpendicular to the surface of the wafer W or at an angle relative thereto.

A support structure in the form of a rotatable chuck 71 is provided for rotatably supporting a wafer W in the process chamber 46. Support pins (not shown) are provided on the upper part of the rotatable chuck 71 at a plurality of positions for supporting the edge portion of the wafer W from the backside of the wafer W, and retaining members 72 are provided for holding the edge portion of the wafer W. In the exemplary embodiment shown in FIG. 3, three retaining members 72 are shown, although this is merely illustrative and thus not intended to be limiting.

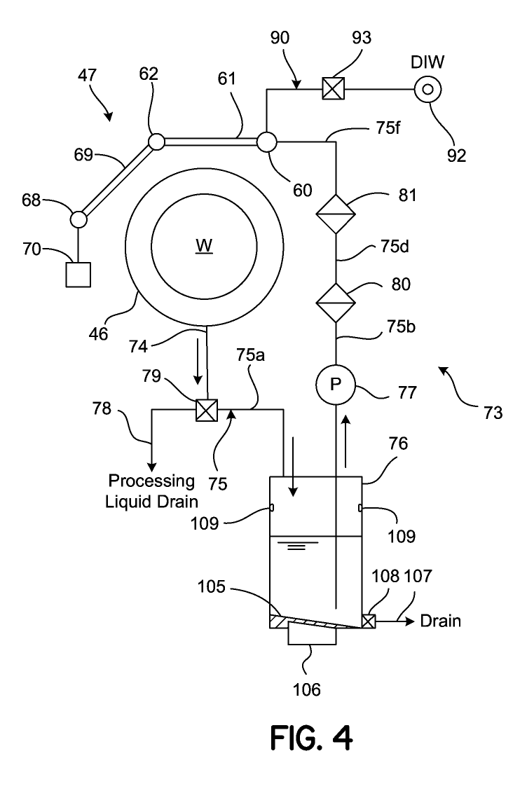

FIG. 4 shows a simplified circuit diagram of circulation of a processing liquid in a substrate processing system, such as system 1, which circulation system may be used in conjunction with embodiments of the invention. Processing liquid/pressurized gas supply system 47 is depicted, including liquid supply nozzle 60 and gas supply nozzle 68 supported by respective first and second arms 61, 69, each rotatably coupled to rotating means 62. Gas supply nozzle 68 is coupled to a pressurized gas source 70. The processing liquid flows through the process chamber 46 in the substrate processing unit 12. The substrate processing unit 12 has a processing liquid circulation system 73 configured for receiving, filtering, and circulating a processing liquid discharged from the process chamber 46 following exposure of the wafer W to the processing liquid. The processing liquid circulation system 73 is connected at one end to a processing liquid discharge line 74 for discharging the processing liquid from the process chamber 46. The processing liquid circulation system 73 is connected at another end to the liquid supply nozzle 60 of processing liquid/pressurized gas supply system 47. A rinse liquid supply 90 is provided for supplying deionized water (DIW) as a rinse liquid and is connected to the liquid supply nozzle 60. The rinse liquid supply 90 is coupled to a rinse liquid supply source 92. A valve 93 is inserted in the rinse liquid supply 90 for controlling the flow of DIW during a rinse process.

A processing liquid circulation line 75 and a processing liquid drain 78 are connected to the processing liquid discharge line 74 by a valve 79 that is configured for controlling the flow of a processing liquid discharged from the process chamber 46 to either the processing liquid drain 78 or to the processing liquid circulation line 75. According to embodiments of the invention, during at least a portion of a substrate cleaning process, the valve 79 directs the processing liquid from the processing liquid discharge line 74 to the processing liquid circulation line 75 and thereafter, at a predetermined time, the valve 79 directs the processing liquid to the processing liquid drain 78 to minimize flow of a processing liquid containing film fragments and other impurities to the processing liquid circulation line 75.

The processing liquid circulation line 75 includes a line 75a coupling the valve 79 to a processing liquid container 76 for storing processing liquid recovered from the process chamber 46 via the processing liquid circulation line 75. The bottom surface 105 of the processing liquid container 76 is inclined. A vibrator 106 is coupled to the backside of the bottom surface 105 for applying supersonic vibrations to the bottom surface 105. A drain line 107 for draining processing liquid from the processing liquid container 76 is positioned near the lowest point of the inclined bottom surface 105. The drain line 107 is connected to a side surface of the processing liquid container 76 through a valve 108. This setup allows for draining the processing liquid from the processing liquid container 76 through the drain line 107, prior to cleaning the inside of the processing liquid container 76. Spray nozzles 109 positioned on the wall of the processing liquid container 76 are provided for cleaning the inside of the processing liquid container 76. The vibrator 106 applies supersonic vibrations to the bottom surface 105 to release film fragments and other impurities that precipitate and settle on the bottom surface 105. The spray nozzles 109 may spray water to clean the interior of the processing liquid container 76 and subsequently spray vapor of isopropyl alcohol (IPA) to dry the interior of the processing liquid container 76. The water sprayed into the processing liquid container 76 can be drained through the drain line 107.

A pump 77 provides processing liquid flow from the processing liquid container 76 through line 75b to a first (coarse) filter 80 for removing large film fragments from the processing liquid flowing through the processing liquid circulation system 73. The once filtered processing liquid flows through line 75d to a second (fine) filter 81 that is finer than the first filter 80. In one example, the first filter 80 may have pore sizes of 50 microns (micron=10⁻⁶ m) and the second filter 81 may have pore sizes of 0.1 micron. The first filter 80 removes larger film fragments from the processing liquid and the second filter 81 substantially removes any remaining smaller film fragments and other impurities from the processing liquid. The presence of the first filter 80 reduces the cleaning/replacing frequency of the second filter 81. In one example, the presence of the first filter 80 in the processing liquid circulation line 75 was observed to decrease the replacement frequency of the second filter 81 by about ⅔. The twice filtered/purified processing liquid is flowed through the line 75f to the liquid supply nozzle 60 and applied again to the wafer W or a subsequent wafer W. Although not shown in FIG. 4, the processing liquid circulation system 73 may contain one or more pressure control devices, one or more flow control devices, additional valves, and one or more flow sensors.

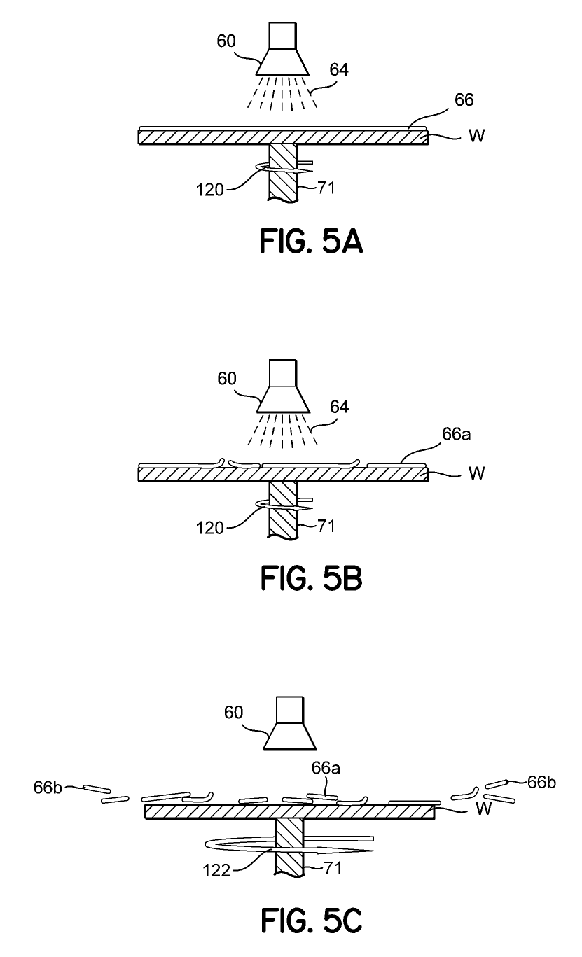

Reference will now be made to FIG. 4 and FIGS. 5A-5C to illustrate a first sequential step of applying a processing liquid from a dispensing device, which may include the liquid supply nozzle 60 described with reference to FIG. 3, in a method in which the application of the processing liquid for dissolving and lifting the film reside of the wafer surface occurs as a first sequential step, and the application of pressurized gas occurs as a second sequential step, according to one embodiment of the invention. However, as described above and as will be described further below, both the processing liquid and the pressurized gas may be applied concurrently. More specifically, FIGS. 5A-5E schematically show cross-sectional views corresponding to processing steps used in removing a film from a wafer according to a first sequential step in one embodiment of the invention.

FIG. 5A schematically depicts a wafer W containing a film 66 formed thereon and which is provided in a process chamber of a substrate processing system, for example the process chamber 46 of substrate processing system 1 depicted in FIGS. 1-3. The wafer W is exposed to a processing liquid 64, such as an organic solvent, from the liquid supply nozzle 60 for a time period to initiate removal of the film 66 from the wafer W. During this time period, the wafer W is rotated at a first speed 120 and the processing liquid 64 is discharged from the process chamber 46 to the processing liquid circulation system 73. Upon exposure of the wafer W to the processing liquid 64, the film 66 may partially dissolve and form film fragments 66a. This is schematically depicted in FIG. 5B. In one example, plasma exposed (hardened) masks and photoresist etch slowly or not at all in the processing liquid 64. The length of time in the processing liquid 64 can, for example, be between about 10 sec and about 30 sec. The first speed 120 can, for example, be less than about 30 revolutions per minute (RPM), and can be about 10 RPM. Alternately, the wafer W is not rotated during this time period and the first speed 120 is 0 RPM.

Next, the exposing of the wafer W to the processing liquid 64 is discontinued and the wafer W is rotated at a second speed 122 greater than the first speed 120 to centrifugally remove a first portion 66b of the film fragments 66a from the wafer W. This is schematically depicted in FIG. 5C. Furthermore, liquid discharge from the process chamber 46 is changed from the processing liquid circulation system 73 to the processing liquid drain 78. The second speed 122 can, for example, between about 100 RPM and about 2000 RPM, and can be about 800 RPM. The second speed 122 can be selected through experimentation to optimize the centrifugal removal of the first portion 66b of film fragments 66a from the wafer W.

According to this embodiment of the invention, in addition to the processing liquid 64, a substantial amount of the first portion 66b of film fragments 66a detached from the wafer W is discharged to the processing liquid drain 78, thereby minimizing the amount of the film fragments 66a that are discharged to the processing liquid circulation system 73. This, in turn, results in lower amounts of film fragments 66a and other impurities that can accumulate in the processing liquid container 76 and in the filters 80 and 81. This results in less frequent cleaning or replacing of the one or more filters and less interruption of the wafer processing.

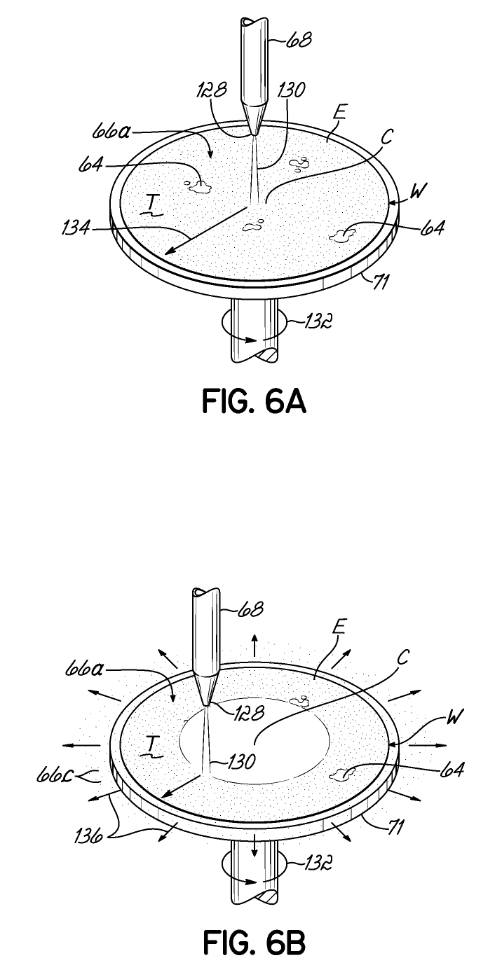

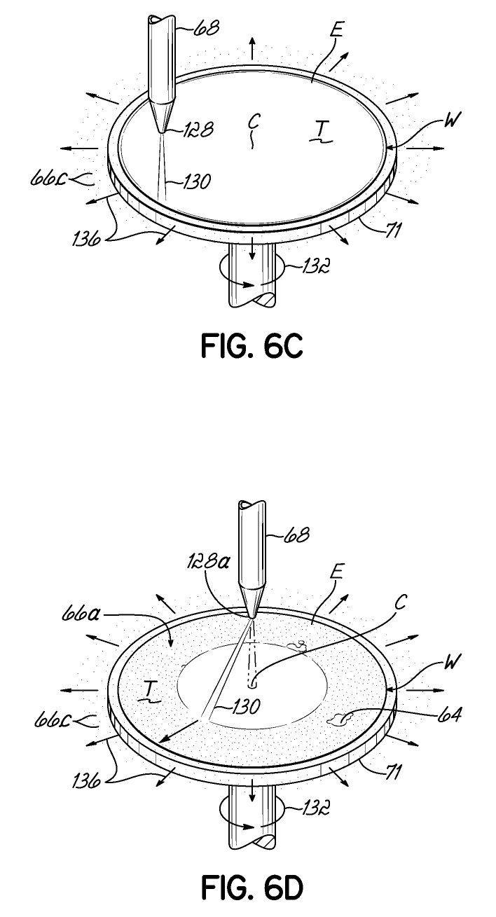

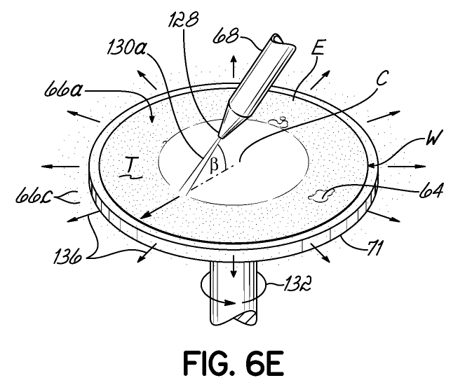

With reference to FIGS. 6A-6E, portions of exemplary embodiments of an apparatus and method for cleaning the surface of a wafer W are depicted. In these embodiments, the second sequential step of applying a pressurized gas from a gas dispensing device, which may include the gas supply nozzle 68 described with reference to FIG. 3, is depicted, in a method in which the application of the processing liquid 64 for dissolving and lifting a first portion 66b of the film residue off the wafer surface occurs as a first sequential step. However, as described above and as will be described further below, both the processing liquid and the pressurized gas may be applied concurrently. With reference back to FIGS. 5A-5C, this second sequential step may occur during the wafer rotation depicted in FIG. 5C, or it may occur thereafter.

In FIGS. 6A-6E, the wafer W is illustrated being supported by a support structure that may, for example, be the rotatable chuck 71 described with reference to FIG. 3. Chuck 71 is rotatable, for example in the direction depicted by arrow 132, and cooperates with the processing liquid/pressurized gas supply system 47, and more particularly, with the liquid supply nozzle 60 and gas supply nozzle 68 thereof, to remove film residue in the form of film fragments 66a from wafer W. Film fragments 66a are depicted in FIGS. 6A-6E by a dotted pattern for illustration purposes. The film fragments 66a are formed in the first sequential step (not shown) wherein processing liquid, such as a solvent, is applied to the surface to dissolve the film to allow it to break apart and at least partially lift it off the surface. A first portion 66b of the film fragments 66a may be removed from the surface during that first sequential step. A second portion 66c is removed during the second sequential step. Advantageously, the second portion 66c consists of all or substantially all of the remaining film fragments 66a following removal of the first portion 66b.

A gas dispensing device, which may for example and without limitation include a gas supply nozzle 68, cooperates with the liquid supply nozzle 60 (FIGS. 5A-5C) to remove most or all of the film fragments 66a from top surface T of the wafer W. To this end, the gas supply nozzle 68 may be actuated to dispense a stream of pressurized gas such as air and/or nitrogen from an outlet 128 onto surface T at any point subsequent to the first sequential step described above with reference to FIGS. 5A-5B, and advantageously, immediately after exposure of the wafer W to the processing liquid 64 is discontinued.

The second sequential step in the process according to one embodiment of the invention is best described with reference to the exemplary sequence depicted in FIGS. 6A-6C. With particular reference to FIG. 6A, the wafer W is shown rotating in the direction of arrow 132 while a stream 130 of pressurized gas is applied by gas supply nozzle 68 onto top surface T. In this embodiment, gas supply nozzle 68 is shown in a starting position where the stream 130 of pressurized gas from outlet 128 contacts the top surface T of the wafer W proximate a center portion C of wafer W. This starting position of wafer W relative to gas supply nozzle 68 and relative to stream 130 is merely illustrative, inasmuch as other alternative starting positions are contemplated.

With particular reference to FIG. 6B, the gas supply nozzle 68 is shown in a position relative to the wafer W that is different from that depicted in FIG. 6A. More particularly, the gas supply nozzle 68 is positioned such that the stream 130 contacts top surface T of the wafer W in a portion between the center portion C and an edge portion E of the wafer W. Movement of the position of the stream 130 relative to the wafer W may be facilitated, for example, by translational motion of gas supply nozzle 68 in the direction of arrow 134 (FIG. 6A) or it may be additionally or alternatively facilitated by translational movement of chuck 71, for example, in a direction opposite to that of arrow 134. Movement of the gas supply nozzle 68 and, more particularly, stream 130 relative to wafer W causes film fragments 66a, including second portion 66c, to be lifted off the surface T and a first fraction of the second portion 66c pushed outwardly and away from wafer W, in the directions depicted by arrows 136. Additionally, this movement of stream 130 relative to wafer W may also remove at least some of the processing liquid 64 that may still be present on top surface T.

With particular reference to FIG. 6C, the gas supply nozzle 68 is shown in a position relative to the wafer W that is different from those depicted in FIGS. 6A and 6B. More particularly, the gas supply nozzle 68 is positioned such that the stream 130 contacts top surface T of the wafer W in a portion proximate edge portion E of the wafer W. Movement of the stream 130 to this position may be also facilitated by movement of at least one of the gas supply nozzle 68 and the chuck 71 relative to one another. In FIG. 6C, most or all of film fragments 66a remaining on the wafer W, i.e., the second fraction of the second portion 66c, are shown having been lifted off the top surface T and having been pushed away from wafer W in the direction of arrows 136. In this regard, and with reference to the above description of FIG. 6B, the first and second fractions of second portion 66c of film fragments 66a are shown having been pushed away from wafer W. Additionally, some or all of the processing liquid 64 may have also been pushed away from wafer W.

While FIGS. 6A-6C depict movement of the position of the stream 130 relative to the wafer W being facilitated by translational movement of either or both of the gas supply nozzle 68 and chuck 71, it is contemplated that this may be achieved in other ways. For example, and with particular reference to FIG. 6D, it is contemplated that the gas supply nozzle 68 may alternatively or additionally have an outlet 128a configured to vary the angle of the stream 130 during the cleaning process and thus cover all portions of the wafer W to thereby lift the second portion 66c of film fragments 66a off top surface T and push them away from wafer W. In this exemplary embodiment, the body of the gas supply nozzle 68 remains in one position and orientation relative to the wafer W.

With particular reference to FIG. 6E, in which like reference numerals refer to like features of FIGS. 6A-6C, the gas supply nozzle 68 having a fixed outlet 1280 is shown applying a stream 130a of pressurized gas that defines an acute angle β relative to top surface T. This positioning is facilitated by an angled orientation of the body of the gas supply nozzle 68 relative to the top surface T of wafer W. Cleaning in this embodiment may be further facilitated by moving one or both of the gas supply nozzle 68 and chuck 71 relative to one another.

According to certain exemplary methods of the invention, the stream 130, 130a of pressurized gas may be applied against the surface of the wafer W immediately after application of the processing liquid, and while rotating chuck 71. As the stream 130, 130a is applied and chuck 71 rotated, the stream 130, 130a is moved relative to the wafer W to scan the top surface T of wafer W from the center portion C radially outward to the edge portion E to force the processing liquid 64 off of the wafer W. At least a portion of any remaining film fragments 66a may be entrained in the processing liquid 64 and thereby forced off the wafer W with the processing liquid.

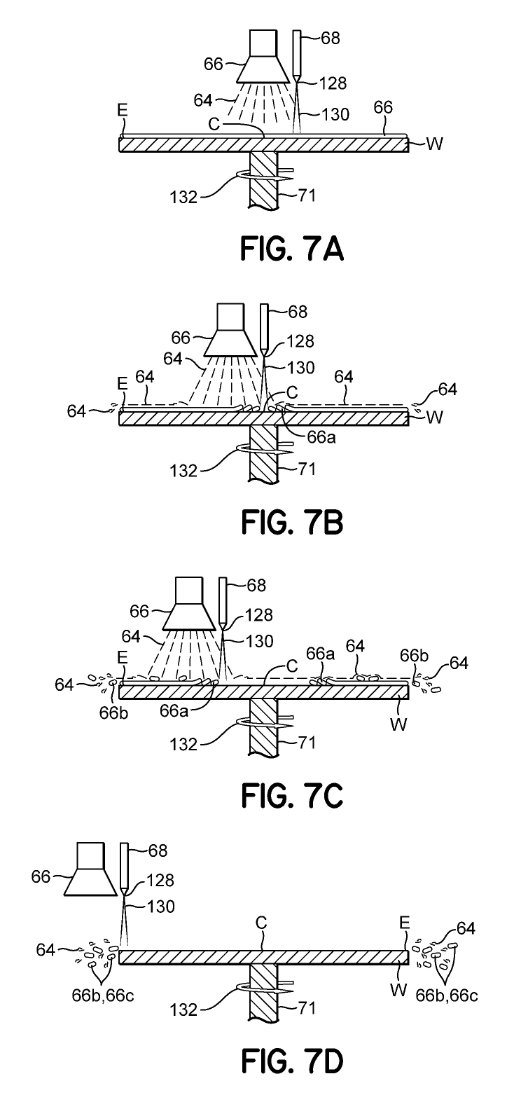

In accordance with another embodiment of the invention, illustrated schematically in cross-section in FIGS. 7A-7D, the method of removing a film residue from a wafer W may comprise concurrent application of the processing liquid 64 and the stream 130 (or 130a, not shown) of pressurized gas. FIG. 7A schematically depicts a wafer W containing a film 66 formed thereon and which is provided in a process chamber of a substrate processing system, for example the process chamber 46 of substrate processing system 1 depicted in FIGS. 1-3. The liquid supply nozzle 60 is positioned above the center portion C of wafer W, and the gas supply nozzle 68 is positioned slightly offset therefrom. The wafer W is exposed to processing liquid 64, such as an organic solvent, from the liquid supply nozzle 60 to initiate removal of the film 66 from the wafer W. Concurrently, the wafer W is exposed to stream 130 of pressurized gas, initially slightly offset from the center portion C. As the processing liquid and pressurized gas are applied to the top surface T of wafer W, the chuck 71 rotates the wafer W as indicated by arrow 132.

As illustrated in FIG. 7B, the film 66 in the center portion C begins to dissolve and form fragments 66a as a result of the application of the processing liquid 64, while the liquid supply nozzle 60 moves outward from the center portion C toward edge portion E and the gas supply nozzle 68 and stream 130 move into the center portion C. Due to the wafer rotation and the application of the pressurized gas, the processing liquid 64 is concurrently forced toward and off of the edge portion E. The film fragments 66a in the center portion lift off the top surface T and also move outward from the center portion C toward edge portion E following the path of the processing liquid 64 and/or entrained in the processing liquid 64. Alternatively, the initiation of the stream 130 may be slightly delayed until the gas supply nozzle 68 is positioned in the center portion C. In another alternative, while the gas supply nozzle 68 is slightly offset, outlet 128a may be used to vary the stream 130 such that stream 130 is initially positioned in the center portion C, and then follows the processing liquid 64 to maintain equal position or an offset position. In yet another alternative, stream 130a may be used, with the body of gas supply nozzle 68 angled such that stream 130a is initially positioned in the center portion C, and the stream 130a may then follow the processing liquid 64 to maintain equal position or an offset position. It may be further appreciated that in any of these embodiments, flow of the pressurized gas stream 130, 130a may be initiated prior to, simultaneously with, or after initiating the flow of the processing liquid 64. Thus, concurrent treatment does not necessarily imply that the flows are simultaneously initiated and/or terminated, but only that there is an overlap in the timing of each flow such that for some time period in the stripping process, both the processing liquid 64 and the pressurized gas stream 130, 130a are each being applied onto the top surface T of wafer W.

Referring to FIG. 7C, the liquid supply nozzle 60 dispensing processing liquid 64 and stream 130 continue to move radially outward toward the edge E, and are shown in an intermediate position on the top surface T similar to the position depicted in FIG. 6B. Film fragments 66a are completely or substantially completely removed from the center portion C of wafer W, as processing liquid 64 and a first portion 66b of film fragments 66a are forced off the edge portion E of wafer W.

Finally, referring to FIG. 7D, the liquid supply nozzle 60 is moved radially away from edge E while stream 130 reaches the edge E, and both first and second portions 66b, 66c of film fragments 66a are pushed off the wafer W. Thus, essentially, the first and second portions 66b, 66c are concurrently lifted off the top surface T and forced in radially motion off the edge portion E of wafer W. Concurrent application of the processing liquid 64 and the stream 130 (or 130a, not shown) of pressurized gas described in FIGS. 7A-7D may result in a more efficient process than the sequential application described in FIGS. 6A-6E, but concurrent application may require more extensive modification of existing apparatus than sequential application, such that both methods are contemplated.

In the various embodiments described above, use of a pressurized gas stream in conjunction with a film removal liquid, such as a stripping solvent, enhances the removal of film residue (fragments) from the wafer surface, decreases the time required to remove the film, and decreases the amount of film removal liquid needed, relative to a process that uses only the film removal liquid. Without being bound by theory, the pressurized gas stream is believed to create an agitating force at the wafer surface that releases remaining film removal liquid and film residue that may be clinging to the surface.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope of the general inventive concept.

What is claimed is:

1. A method of removing a film residue from a wafer in a substrate processing system, comprising:
exposing a surface of the wafer to a processing liquid to thereby lift a first portion of the film residue off the surface of the wafer; and
applying a stream of pressurized gas against the surface of the wafer to remove a second portion of the film residue from the wafer.

2. The method of claim 1, further comprising:
rotating the wafer relative to the stream of pressurized gas.

3. The method of claim 1, wherein the stream of pressurized gas is applied subsequent to exposing the surface of the wafer to the processing liquid.

4. The method of claim 1, further comprising:
moving at least one of the stream of pressurized gas and the wafer relative to the other of the stream of pressurized gas and the wafer between first and second portions of the surface of the wafer.

5. The method of claim 1, further comprising:
moving the stream of pressurized gas between a center portion of the wafer and an edge portion thereof.

6. The method of claim 5, wherein moving the stream of pressurized gas includes moving the stream from the center portion of the wafer radially outward to the edge portion thereof.

7. The method of claim 1, wherein exposing a surface of the wafer to a processing liquid includes applying an organic solvent to the surface of the wafer.

8. The method of claim 1, wherein applying the stream of pressurized gas against the surface of the wafer removes the processing liquid from the surface of the wafer.

9. The method of claim 1, wherein the stream of pressurized gas includes nitrogen.

10. The method of claim 1, wherein the stream of pressurized gas defines an acute angle relative to the surface of the wafer.

11. The method of claim 1, wherein the stream of pressurized gas is applied concurrently with exposing the surface of the wafer to the processing liquid.

12. The method of claim 11, wherein applying the stream of pressurized gas includes pulsing the stream to create short periodic bursts of pressurized gas against the surface of the wafer.

13. A method of removing a film residue from a wafer in a substrate processing system, comprising:
exposing a surface of the wafer to a processing liquid to thereby lift a first portion of the film residue off the surface of the wafer; and
while rotating the wafer, applying a stream of pressurized gas against the surface of the wafer from a center portion thereof radially outwardly to an edge portion thereof to remove the processing liquid and a second portion of the film residue from the wafer.

14. The method of claim 13, wherein the processing liquid comprises an organic solvent and the pressurized gas comprises pressurized nitrogen.

15. The method of claim 13, wherein the applying from the center portion radially outwardly to the edge portion includes moving a gas supply nozzle emitting the stream in a translational motion relative to the wafer.

16. The method of claim 13, wherein the applying from the center portion radially outwardly to the edge portion includes moving a support structure supporting the wafer in a translational motion relative to the wafer.

17. The method of claim 13, wherein the applying from the center portion radially outwardly to the edge portion includes varying an output angle of a gas supply nozzle emitting the stream relative to the wafer.

18. The method of claim 13, wherein the stream of pressurized gas is applied subsequent to exposing the surface of the wafer to the processing liquid.

19. The method of claim 13, wherein the stream of pressurized gas is applied concurrently with exposing the surface of the wafer to the processing liquid.

20. The method of claim 19, wherein applying the stream of pressurized gas includes pulsing the stream to create short periodic bursts of pressurized gas against the surface of the wafer.

21. An apparatus for removing a film residue from a wafer in a substrate processing system, comprising:
a support structure adapted to support the wafer;
a liquid dispensing device adapted to dispense a processing liquid onto a surface of the wafer; and
a gas dispensing device cooperating with said liquid dispensing device and adapted to apply a stream of pressurized gas onto the surface of the wafer to thereby lift the film residue off the surface of the wafer.

22. The apparatus of claim 21, wherein said support structure is rotatable and adapted to rotate the wafer relative to the stream of pressurized gas.

23. The apparatus of claim 21, wherein at least one of said support structure and said gas dispensing device is movable relative to the other of said support structure and said gas dispensing device to thereby cause the stream of pressurized gas to move from a first position to a second position on the surface of the wafer.

24. The apparatus of claim 21, wherein said gas dispensing device is positioned to apply the stream of pressurized gas at an acute angle relative to the surface of the wafer.

25. The apparatus of claim 21, wherein said liquid dispensing device includes a body and an outlet coupled to said body, said outlet being adapted to vary an angle of the stream of pressurized gas relative to the surface of the wafer.
